(19) United States
(12) Patent Application Publication
(10) Pub. No.: US 2016/0111727 A1
(43) Pub. Date: Apr. 21, 2016

(54) Metal-Ion Battery with Offset Potential Material

(71) Applicant: Ford Global Technologies, LLC, Dearborn, MI (US)

(72) Inventors: Feng LI, Troy, MI (US); Chi PAIK, Brownstown Twp., MI (US); Jun YANG, Bloomfield Hills, MI (US); Mark Stephen RICKETTS, Windsor (CA)

(21) Appl. No.: 14/518,390

(22) Filed: Oct. 20, 2014

(51) Int. Cl. H01M 4/62; H01M 4/13; H01M 4/133; H01M 2/02; H01M 10/04; H01M 4/134; H01M 4/131; H01M 10/0525; H01M 4/66

(52) U.S. Cl. CPC H01M 4/628; H01M 10/0525; H01M 4/13; H01M 4/133; H01M 4/661; H01M 10/0427; H01M 4/134; H01M 4/131; H01M 2/024; H01M 2220/20

(57) ABSTRACT

A metal-ion battery includes an anode assembly and a cathode assembly ionically coupled by an electrolyte. The anode assembly includes a current collector and an anode material capable of intercalation of metal-ions. When the battery is at rest, ionic transfer between the anode and cathode at a minimum and the anode assembly potential with respect to the electrolyte may increase. The increased potential may exceed the reduction potential of the current collector material causing ions to erode from the current collector and contaminate the cathode. The use of a metal, metal alloy or metal compound reduces the rest potential and erosion of the current collector. For example, a lithium foil physically in contact with a copper current collector in a lithium-ion battery reduces the overall anode potential thereby reducing copper dissolution.

### TECHNICAL FIELD

This application is generally related to the structure of metal-ion batteries.

### BACKGROUND

Electrochemical batteries including metal-ion batteries and rechargeable metal-ion batteries include electrodes. An electrode may be an anode (negative charge terminal) or a cathode (positive charge terminal). Typically, the anode (or anode assembly) includes an anode current collector and an anode active material while the cathode (or cathode assembly) includes a cathode current collector and a cathode active material. The anode assembly and cathode assembly may be separated by a microporous layer that allows ions to pass between the anode assembly and the cathode assembly while maintaining the separation of the anode and cathode active material. The electrodes of the metal-ion battery may be immersed in an electrolyte, contained within the battery, in which the electrolyte may be a liquid (an aqueous liquid, a non-aqueous liquid) or solid (ceramic, dry polymer, gel or power).

Electrochemical batteries may have many configurations including button cell, cylindrical, prismatic or pouch cells. The electrochemical batteries may be used in hybrid-electric and pure electric vehicles as a traction battery to provide power for propulsion and may also provide power for some accessories.

### SUMMARY

A metal-ion battery includes an anode assembly immersed in an electrolyte. The anode assembly includes a current collector with an anode material on a first side and an offset potential material on the second side. The anode material may have a first rest potential in reference to the electrolyte. The anode material may be in contact with and sandwiched between the current collector first side and a separator. The offset potential material may have a second rest potential in reference to the electrolyte. The offset potential material may be in contact with the current collector second side and have a second rest potential. The second rest potential may reduce a resultant potential of the anode assembly to reduce dissolution of the current collector.

A rechargeable alkali-metal-ion battery includes a layered electrode assembly. The layered electrode assembly includes an electrochemical active material with a first rest potential, a current collector layered adjacently and contacting the electrochemical active material, and an offset potential material with a second rest potential. The offset potential material may be layered adjacently and in contact with the current collector. The second rest potential may reduce an average potential of the layered electrode assembly. The reduction in potential may reduce dissolution of the current collector. The battery further includes an electrolyte in ionic contact with the layered electrode assembly.

A rechargeable lithium-ion battery includes an anode immersed in an electrolyte. The Anode includes a copper (Cu) current collector having a first and second side. A carbonaceous anode material may be in contact with and sandwiched between the first side and a separator. A lithiated material may be in contact with a predetermined amount (e.g., at least 10%) of the second side.

### BRIEF DESCRIPTION OF THE DRAWINGS

FIG. 1 is a diagram of a hybrid vehicle illustrating typical drivetrain and energy storage components.

FIG. 2 is a diagram of a possible battery pack arrangement comprised of multiple cells, and monitored and controlled by a Battery Energy Control Module.

FIG. 3A is a diagram of an exemplary electrochemical cell.

FIG. 3B is a diagram of an exemplary battery including multiple electrochemical cells.

FIG. 3C is a cross-sectional view of the exemplary metal-ion battery 320.

FIG. 4 is a cross-sectional view of an exemplary metal-ion battery.

FIG. 5 is an exploded perspective view of an electrochemical cell.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

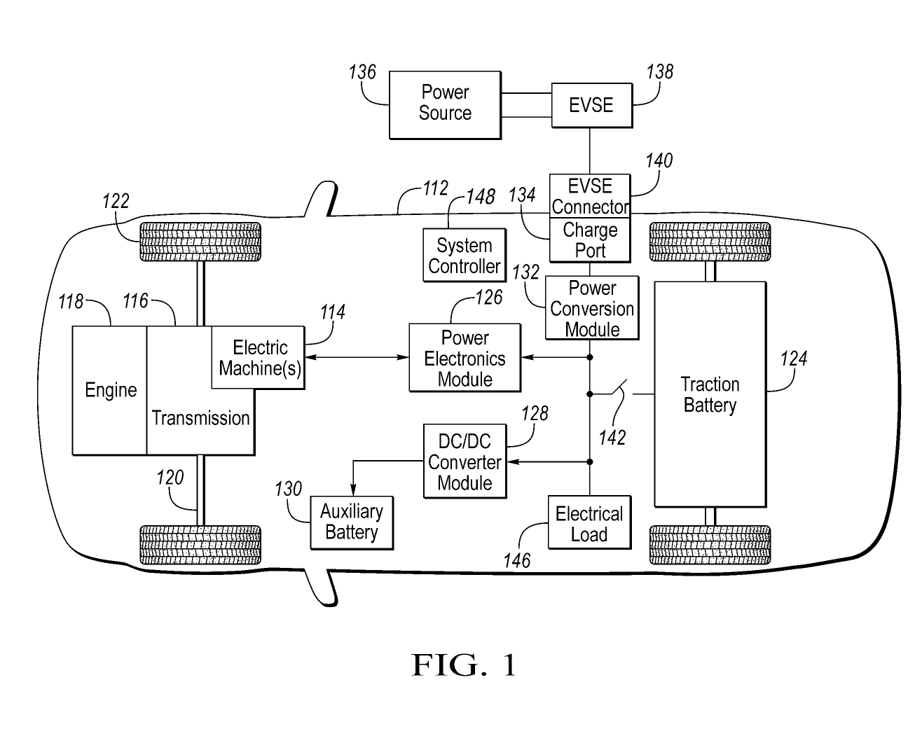

FIG. 1 depicts a typical plug-in hybrid-electric vehicle (HEV). A typical plug-in hybrid-electric vehicle 112 may comprise one or more electric machines 114 coupled to a hybrid transmission 116. The electric machines 114 may be capable of operating as a motor or a generator. In addition, the hybrid transmission 116 is coupled to an engine 118. The hybrid transmission 116 is also coupled to a drive shaft 120 that is coupled to the wheels 122. The electric machines 114 can provide propulsion and deceleration capability when the engine 118 is turned on or off. The electric machines 114 also act as generators and can provide fuel economy benefits by recovering energy that would normally be lost as heat in the friction braking system. The electric machines 114 may also reduce vehicle emissions by allowing the engine 118 to operate at more efficient conditions (engine speeds and loads) and allowing the hybrid-electric vehicle 112 to be operated in electric mode with the engine 118 off under certain conditions.

A traction battery or battery pack 124 stores energy that can be used by the electric machines 114. A vehicle battery pack 124 typically provides a high voltage DC output. The traction battery 124 is electrically connected to one or more power electronics modules. One or more contactors 142 may isolate the traction battery 124 from other components when opened and connect the traction battery 124 to other components when closed. The power electronics module 126 is also electrically connected to the electric machines 114 and provides the ability to bi-directionally transfer energy between the traction battery 124 and the electric machines 114. For example, a typical traction battery 124 may provide a DC voltage while the electric machines 114 may use a three-phase AC current to function. The power electronics module 126 may convert the DC voltage to a three-phase AC current used by the electric machines 114. In a regenerative mode, the power electronics module 126 may convert the three-phase AC current from the electric machines 114 acting as generators to the DC voltage used by the traction battery 124. The description herein is equally applicable to a pure electric vehicle. For a pure electric vehicle, the hybrid transmission 116 may be a gear box connected to an electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other vehicle loads. Other high-voltage electrical loads 146, such as compressors and electric heaters, may be connected directly to the high-voltage without the use of a DC/DC converter module 128. The electrical loads 146 may have an associated controller that operates the electrical load 146 when appropriate. The low-voltage systems may be electrically connected to an auxiliary battery 130 (e.g., 12V battery).

The vehicle 112 may be an electric vehicle or a plug-in hybrid vehicle in which the traction battery 124 may be recharged by an external power source 136. The external power source 136 may be a connection to an electrical outlet. The external power source 136 may be electrically connected to electric vehicle supply equipment (EVSE) 138. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 12. The charge port 134 may be any type of port configured to transfer power from the EVSE 138 to the vehicle 112. The charge port 134 may be electrically connected to a charger or on-board power conversion module 132. The power conversion module 132 may condition the power supplied from the EVSE 138 to provide the proper voltage and current levels to the fraction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically connected may transfer power using a wireless inductive coupling.

The various components discussed may have one or more associated controllers to control and monitor the operation of the components. The controllers may communicate via a serial bus (e.g., Controller Area Network (CAN)) or via discrete conductors. In addition, a system controller 148 may be present to coordinate the operation of the various components. A traction battery 124 may be constructed from a variety of chemical formulations. Typical battery pack chemistries may be lead acid, nickel-metal hydride (NIMH) or Lithium-Ion.

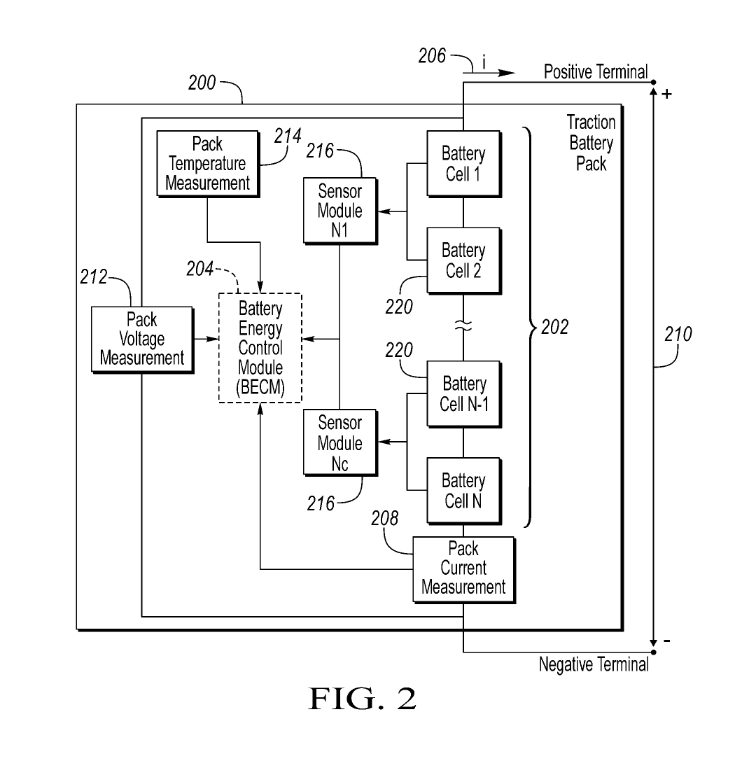

FIG. 2 shows a typical fraction battery pack 200 in a simple series configuration of N battery cells 202. Battery packs 200 may be composed of any number of individual battery cells connected in series or parallel or some combination thereof. A typical system may have a one or more controllers, such as a Battery Energy Control Module (BECM) 204 that monitors and controls the performance of the traction battery 200. The BECM 204 may monitor several battery pack level characteristics such as pack current 206 that may be monitored by a pack current measurement module 208, pack voltage 210 that may be monitored by a pack voltage measurement module 212 and pack temperature that may be monitored by a pack temperature measurement module 214. The BECM 204 may have non-volatile memory such that data may be retained when the BECM 204 is in an off condition. Retained data may be available upon the next ignition cycle. A battery management system may be comprised of the components other than the battery cells and may include the BECM 204, measurement sensors and modules (208, 212, 214), and sensor modules 216. The function of the battery management system may be to operate the fraction battery in a safe and efficient manner.

In addition to the pack level characteristics, there may be battery cell 220 level characteristics that are measured and monitored. For example, the voltage, current, and temperature of each cell 220 may be measured. A system may use a sensor module 216 to measure the characteristics of individual battery cells 220. Depending on the capabilities, the sensor module 216 may measure the characteristics of one or multiple of the battery cells 220. The battery pack 200 may utilize up to N_{c} sensor modules 216 to measure the characteristics of each of the battery cells 220. Each sensor module 216 may transfer the measurements to the BECM 204 for further processing and coordination. The sensor module 216 may transfer signals in analog or digital form to the BECM 204. In some embodiments, the functionality of the sensor module 216 may be incorporated internally to the BECM 204. That is, the sensor module 216 hardware may be integrated as part of the circuitry in the BECM 204 wherein the BECM 204 may handle the processing of raw signals.

The battery cell 200 and pack voltages 210 may be measured using a circuit in the pack voltage measurement module 212. The voltage sensor circuit within the sensor module 216 and pack voltage measurement circuitry 212 may contain various electrical components to scale and sample the voltage signal. The signals to be measured may be routed to inputs of an analog-to-digital (A/D) converter within the sensor module 216 or BECM 204 for conversion to a digital value. The sensor module 216, pack voltage sensor 212 and BECM 204 may contain circuitry to ascertain the status of the voltage measurement components. In addition, a controller within the sensor module 216 or the BECM 204 may perform signal boundary checks based on expected signal operating levels.

Electrochemical batteries include dry cell batteries, wet cell batteries, Alkaline cell batteries and metal-ion batteries. Metal-ion batteries, specifically lithium-ion batteries are important in everyday life. Lithium-ion batteries exhibit high volumetric and gravimetric energy densities in comparison with other rechargeable batteries. Lithium-ion batteries include a separator, an electrolyte, electroactive materials and current collectors. Typically, the separator is a polymeric membrane that forms a microporous layer to allow ion transfer while maintaining the separation of the anode and cathode active materials. The positive electrode active material is a lithiated transition metal oxide, (e.g., lithium nickel cobalt manganese oxide Li(Ni_{1/3}Co_{1/3}Mn_{1/3})O₂, lithium cobalt oxide LiCoO₂, lithium iron phosphate, LiFePO₄, or lithium manganese oxide LiMn₂O₄). The negative anode material allows intercalation of the battery ions and may include materials such as a carbonaceous material (e.g., graphite, graphene, hard carbon and soft carbon), Lithium Titanium Oxide (i.e., Li₄Ti₅O₁₂ or LTO), lithium titanate, silicon material, or nanomaterials. The electrolyte may be either a solid (e.g., a gel polymer electrolyte) or a liquid (e.g., a non-aqueous electrolyte). A liquid electrolyte is usually a Li salt and various solvents from the ester, ether, or carbonate families. Aluminum foil is often used as the positive electrode current collector and copper foil is often used as the negative electrode current collector. Currently, copper foil (e.g., Cu plated foil, Cu foil, Cu foil mesh and Cu plated anode material) is the predominant anode current collector material for lithium ion cells; however other metals, compositions or materials (e.g., a Cu alloy) may be used as the anode current collector. The use of Cu for a current collector has advantages but also has some disadvantages. One disadvantage is that during long-term storage, the lithium ion cell experiences capacity loss. The cell capacity loss results in a reduced cell voltage in which the cell voltage may drop to a level below the normal minimum voltage. That is, the lithium ion battery storage may result in over-discharge. During over-discharge, the negative electrode may reach a high potential relative to the electrolyte. This high potential leads to the current collector (e.g., Cu current collector) potential rising above the reduction potential for the current collector material (e.g., copper). This high potential may be attributed to the current collector erosion/corrosion (i.e., Cu dissolution in a Cu current collector). Currently, there is no effective method to prevent copper current collector erosion/corrosion from occurring in Li-ion batteries.

The over-discharge, especially during a period of storage or non-use, of a metal-ion battery (e.g., Li-ion battery) can drive the negative electrode potential (i.e., anode potential) to be higher than 3 volts (relative to the electrolyte and Li⁺/Li⁺), causing the lithium ion cell capacity and performance to decrease. Over discharge when a Li-ion cell is repeatedly forced and/or maintained for an extended period of time at low voltage, such as 1V, causes copper dissolution and anode solid electrolyte interface (SEI) layer breakdown, resulting in capacity loss. It has been demonstrated that the dissolution of the copper current collector and migration of Cu²⁺ ions through the separator results in the plating of the Cu onto the cathode active material surface which in turn may cause a reduction in the cathode active material surface area which reduces battery capacity, an internal short of the battery or a large self-discharge current.

A structure to reduce the current collector metal dissolution (e.g., copper dissolution) of the anode current collector during storage and over-discharge includes a low potential material placed in contact with the back side of the current collector, and immersed in the electrolyte of the cell. Thus the copper metal will be kept at a lower potential during periods of inactivity. The back side of the current collector is the side which is typically adjacent to the battery case, housing or enclosure, and is typically not coated with an active material.

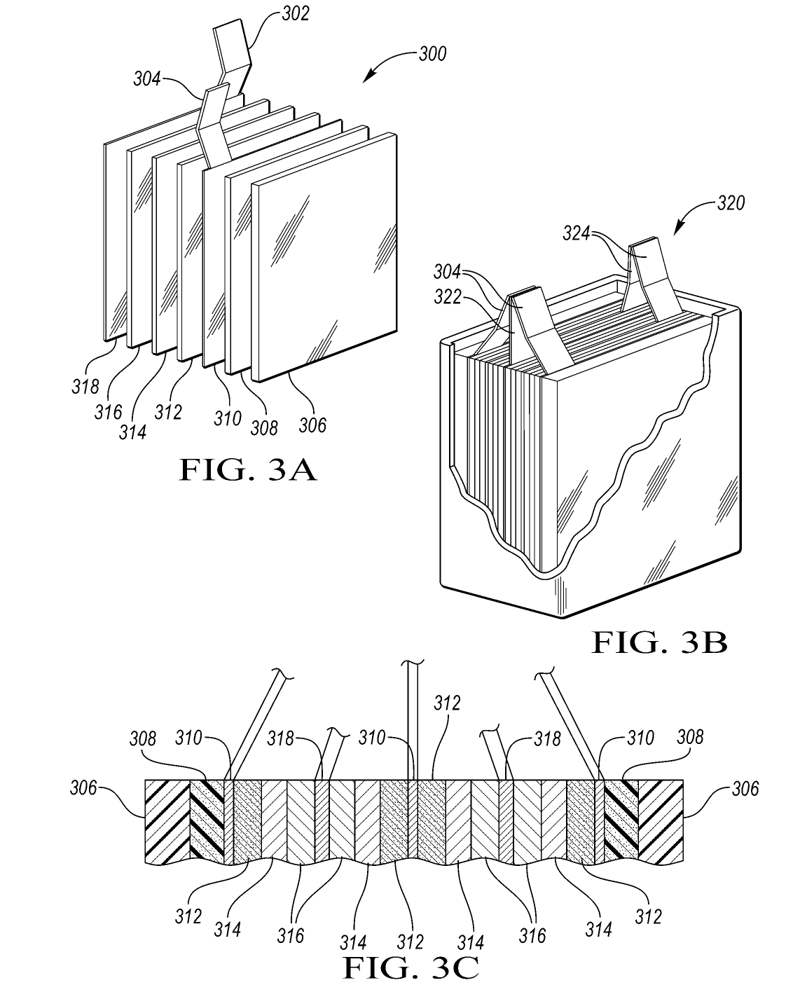

FIG. 3A is a diagram of an exemplary electrochemical cell 300. The electrochemical cell 300 may have multiple configurations including a prismatic cell, a pouch cell, a cylindrical cell or a button cell. The electrochemical cell 300 includes an anode tab (negative tab, negative terminal) 302 and a cathode tab (positive tab, positive terminal) 304. Electrochemical cells are typically arranged as a layered structure. In this diagram, the case 306 may be viewed as the first layer which is typically used to contain the battery cell components and the electrolyte. Typically, the case 306 is adjacent to the anode current collector 310 in which a material is not between the anode current collector 310 and the case 306. However, to reduce the dissolution of the anode current collector 310, a rest or offset potential material 308 is placed in contact with the anode current collector 310 and between the case 306 and anode current collector 310. This offset potential material 308 may be one of an alkali metal, an alkaline earth metal, an alkali metal alloy, an alkaline earth metal alloy, an alkali metal compound and an alkaline earth metal compound. The active anode material 312 allows intercalation of the battery ions. For example, in a Li-ion battery the active anode material allows the intercalation of Li⁺ ions. Materials that allow the intercalation of Li⁺ include carbonaceous materials (e.g., graphite, graphene, hard carbon and soft carbon), Lithium Titanium Oxide (i.e., Li₄Ti₅O₁₂ or LTO), silicon material or nanomaterials. The anode material 312 is adjacent to a separator material 314, which provides isolation between the anode material 312 and the cathode material 316. The separator 314 is a thin microporous membrane that allows the transfer of positive ions to the anode material 312 from the cathode material 314 during battery discharge, and vice versa during charging. The separator 314 is a thin membrane, typically approximately 15 μm thick, and has properties that promote ionic exchange between the anode material 312 and the cathode material 316 readily. The cathode material 316 in a metal-ion battery is typically a metal oxide. For example, the cathode material for a Li-ion battery may include lithium nickel cobalt manganese oxide, Li(Ni_{1/3}Co_{1/3}Mn_{1/3})O₂, lithium cobalt oxide, LiCoO₂, lithium iron phosphate, LiFePO₄, lithium manganese oxide, LiMn₂O₄, and Lithium Nickel Cobalt Aluminum Oxide, Li(Ni_{0.8}Co_{0.15}Al_{0.05})O₂. These non-stoichiometric compounds are presented with exemplary elemental compositions and are not intended to be limiting as multiple elemental compositions ratios may be used. The cathode material 316 is in contact with a cathode current collector 318, which may be a conductive metal, alloy or composition. For example, a cathode current collector in a Li-ion battery is typically aluminum (e.g., Al foil).

FIG. 3B is a diagram of an exemplary battery including multiple electrochemical cells. An electrochemical battery 320 may include a plurality of individual electrochemical cells electrically connected in series or in parallel or a combination thereof. The battery 320 is shown to include five individual electrochemical cells electrically connected in parallel. When the anode interior cell assembly tabs 322 and the anode assembly tabs 304 are connected in parallel, the voltage of each individual cell electrode influences the overall voltage of the battery. For example, the potential of the anode tab 322 connected in parallel with the anode tabs 304 would combine to provide a resultant potential being the average potential based on charge and electric forces of each anode tab (322 and 304). FIG. 3C is a cross-sectional view of the exemplary metal-ion battery 320.

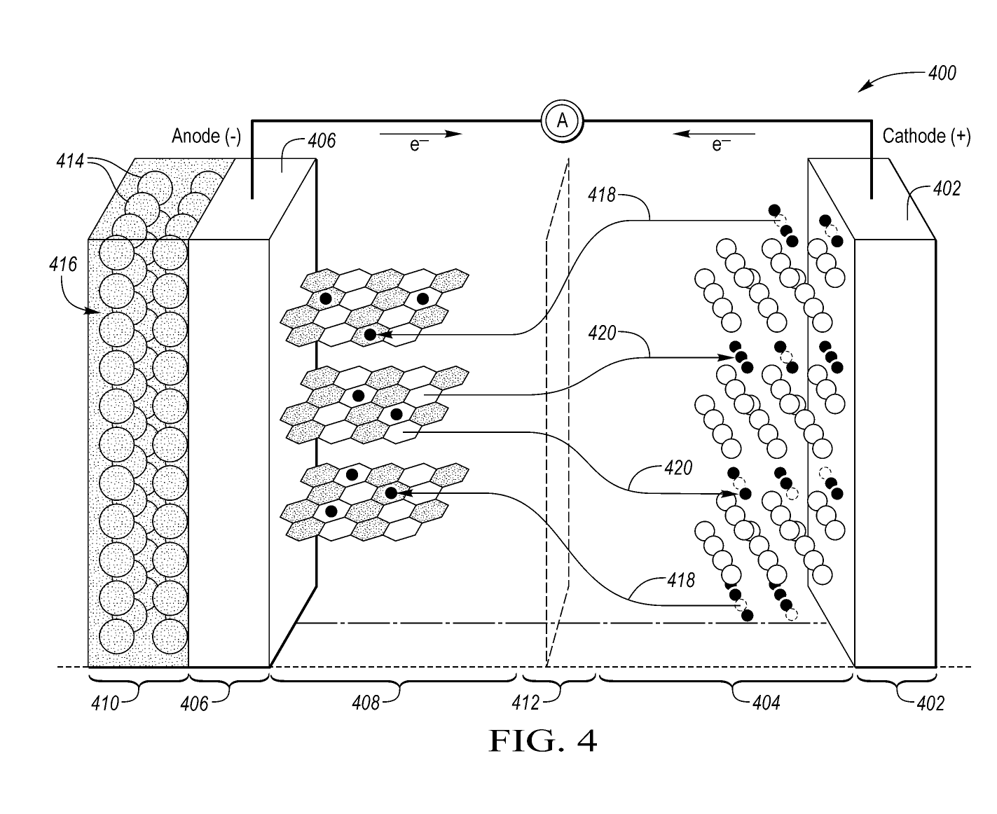

FIG. 4 is a cross-sectional view of an exemplary metal-ion battery 400. The metal-ion battery (e.g., Li-ion battery) 400 includes a cathode current collector 402, which is electrically conductive (e.g., Al and Al alloy). In contact with the cathode current collector 402 is a cathode active material 404. The cathode active material 404 in a metal-ion battery is typically a transition metal oxide. The metal-ion battery 400 also includes an anode current collector 406 which is electrically conductive (e.g., Cu, Cu foil and Cu alloy). In contact with the anode current collector 406 is an anode active material 408. The anode active material 408 in a metal ion battery is typically a material which is receptive to the metal-ion intercalation such that a charge may be moved into and out of intercalation sites. A separator membrane 412 is located between the anode active material 408 and the cathode active material 404. The separator membrane 412 is a thin membrane which allows the cathode active material 404 and anode active material 408 to be physically close in proximity while maintaining active material separation. Physical close proximity of the electrode active materials is one factor in attributing to a low resistivity between the anode material 408 and the cathode material 404. The interaction of the anode active material 408 and cathode active material 404 is what drives the battery cell voltage.

The operating voltage of a battery is generally lower than the standard cell voltage dues to a few factors, first is cell current and cell internal resistance, another factor is activation polarization at the anode and cathode, and also a factor is the concentration polarizations at the anode and cathode. When the battery is at rest, the first factor is minimized due to the lack of an external current. As the battery discharges (self-discharge), the potential at the electrodes changes and the differential voltage between the two electrodes approaches zero. As this occurs, the potential of the anode with respect to the electrolyte increases. As the anode potential with respect to the electrolyte increases to a value greater than a predetermined value (e.g., 1.5V and 2.0V) the anode current collector material may exceed the reduction voltage causing ions of the anode current collector to become ionic (e.g., Cu→Cu²⁺+2e⁻). The dissolution of the current collector material (e.g., Cu) into the electrolyte may result in a contamination of the electrolyte in which the material (e.g., Cu) in solution may deposit on the cathode resulting in loss of interstitial sites for active metal-ion storage or it may cause internal shorting.

The use of an offset material 410 may reduce the inactive or rest potential of the battery anode such that the anode current collector does not reach the reduction voltage of the current collector material. Thus, reducing the ionic conversion of the anode current collector material. The offset material may include a metal 414 which when in solid form has an electron cloud 416 encompassing the material. The metal 414 may also be the same metal as the base metal for the metal-ion battery. For example, a lithium foil may be used in a Li-ion battery. When the lithium foil is placed in contact with a copper current collector opposite the anode active material, the lithium foil will act as a sacrificial anode reducing the potential of the anode assembly (anode active material, anode current collector and offset material). Due to the distance from the cathode and thereby the resistivity, the offset material generally will not become ionic, but will reduce the current collector voltage to reduce dissolution of the current collector material. This reduction in current collector voltage is applied to all current collectors electrically connected to the anode assembly in contact with the offset material. A predetermined surface area (e.g., 5%, 10%, 20%) being larger than a threshold area in relation to the total surface area of the anode or all anodes electrically connected in parallel is recommended to reduce the current collector voltage to an acceptable level. For example with a Li-ion battery, coverage of 10% of the surface area of a Cu anode current collector by a lithium metal reduced the Cu dissolution by reducing the anode rest potential to lower than 2 volts with respect to the electrolyte. Generally, the side of the current collector adjacent to the case is not coated with an active material. Here an offset material placed in contact with the current collector (on the generally bare side) may be used to increase battery life by reducing Cu dissolution/Cu contamination. In the example of a Li-ion battery, the offset potential material 410 may include a lithium metal, a lithium alloy, a lithium compound, or other lithiated material in order to keep the copper metal potential lower than 2 V vs. Li/Li+ in the electrolyte. This method can effectively prevent copper corrosion and thus extend the lithium ion cell storage life. The transfer of ions from the anode active material to the cathode material 420 results in discharging the battery while electrons travel from the anode to the cathode. And the transfer of ions from the cathode active material to the anode material 422 results in charging the battery while electrons travel from the cathode to the anode.

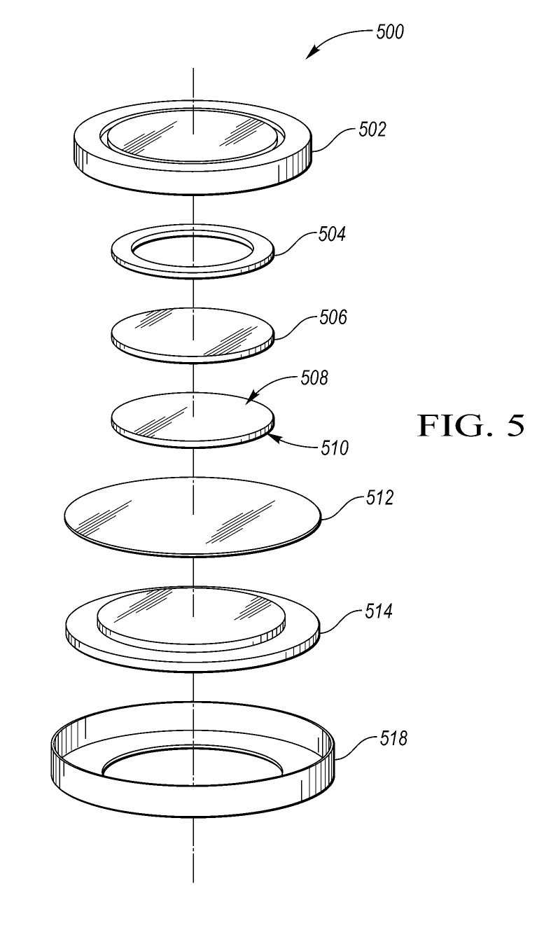

FIG. 5 is an exploded perspective view of an electrochemical cell. The use of a lithiated material in contact with a copper current collector was demonstrated via a test coin cell 500 as shown in FIG. 5. The test coin cell 500 includes a cap 502, which is the positive terminal, and a wave spring/steel plate 504. A sheet of lithium foil 506 directly contacts the copper anode current collector 508. The copper anode current collector 508 is a copper plating on one side of the anode material 510. The anode material 510 is graphite, and the cathode 514 is a lithium nickel cobalt manganese oxide Li(Ni_{1/3}Co_{1/3}Mn_{1/3})O₂. The separator/electrolyte 512 is a 1.0 mol·L⁻¹ lithium hexafluorophosphate LiPF₆/ethylene carbonate (EC)+dimethyl carbonate (DMC)+ethylmethyl carbonate (EMC). The test coin cell 500 was assembled by pressing the layers into a can 518 sealed in an argon filled glove box. The cell was tested on a Solartron 1480 tester. The results indicated that the test cell operationally performed similar to a normal full coin cell with improved rest state characteristics including current collector dissolution.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A metal-ion battery comprising:
an anode assembly immersed in an electrolyte and including
a current collector having a first and second side,
an anode material, having a first rest potential in reference to the electrolyte, in contact with and sandwiched between the first side and a separator, and
an offset potential material, having a second rest potential in reference to the electrolyte, in contact with the second side, wherein the second rest potential reduces a resultant potential of the anode assembly to reduce dissolution of the current collector.

2. The battery of claim 1, wherein the offset potential material is an alkali metal, an alkaline earth metal, an alkali metal alloy, an alkaline earth metal alloy, an alkali metal compound or an alkaline earth metal compound.

3. The battery of claim 1, wherein the metal-ion battery is a lithium-ion battery.

4. The battery of claim 3, wherein the offset potential material is lithium, a lithium alloy or a lithium compound.

5. The battery of claim 1, wherein the offset potential material is in contact with at least 10% of the second side.

6. The battery of claim 1, wherein the anode material is carbonaceous and substantially free of lithium.

7. The battery of claim 1, further comprising a cathode immersed in the electrolyte, wherein the cathode is a lithium nickel cobalt manganese oxide, a lithium cobalt oxide, a lithium iron phosphate, or a lithium manganese oxide.

8. The battery of claim 1, wherein the current collector is a copper plated foil or a copper mesh foil.

9. The battery of claim 1, wherein the battery is a prismatic, pouch or button cell.

10. The battery of claim 1, wherein the anode material is silicon or lithium titanate.

11. A rechargeable alkali-metal-ion battery comprising:
a layered electrode assembly including,
an electrochemical active material having a first rest potential,
a current collector layered adjacently and contacting the electrochemical active material, and
an offset potential material, having a second rest potential, layered adjacently and in contact with the current collector, wherein the second rest potential reduces an average potential of the layered electrode assembly to reduce dissolution of the current collector; and
an electrolyte in ionic contact with the layered electrode assembly.

12. The battery of claim 11, wherein the electrochemical active material is silicon, titanium oxide, graphite, graphene, hard carbon or soft carbon, and is substantially free of lithium.

13. The battery of claim 11, wherein the current collector is one of a copper metal, copper plated foil or copper mesh foil.

14. The battery of claim 11, wherein the alkali-metal-ion battery is a lithium-ion battery.

15. The battery of claim 14, wherein the offset potential material is lithium, a lithium alloy or a lithium compound.

16. The battery of claim 14, wherein the offset potential material is layered adjacently and in contact with greater than a threshold area of the current collector.

17. A rechargeable lithium-ion battery comprising:
an anode immersed in an electrolyte and including
a copper current collector having a first and second side,
a carbonaceous anode material in contact with and sandwiched between the first side and a separator, and
a lithiated material in contact with at least 10% of the second side.

18. The battery of claim 17, wherein the carbonaceous anode material is graphite, graphene, hard carbon or soft carbon, and is substantially free of lithium.

19. The battery of claim 17, wherein the lithiated material is lithium, a lithium alloy or a lithium compound.

20. The battery of claim 17, wherein the copper current collector is copper plated foil or copper mesh foil.
